(19) United States
(12) Patent Application Publication
(10) Pub. No.: US 2006/0062507 A1
(43) Pub. Date: Mar. 23, 2006

(54) Bistable all optical devices in non-linear photonic crystals

(76) Inventors: Mehmet Fatih Yanik, Stanford, CA (US); Shanhui Fan, Palo Alto, CA (US); Marin Soljacic, Belmont, MA (US); John D. Joannopoulos, Belmont, MA (US)

Correspondence Address: PARSONS HSUE & DE RUNTZ LLP, 595 MARKET STREET, SUITE 1900, SAN FRANCISCO, CA, 94105, US

(21) Appl. No.: 11/226,713

(22) Filed: Sep. 13, 2005

Related U.S. Application Data
(63) Continuation-in-part of application No. 10/421,337, filed on Apr. 23, 2003.
(60) Provisional application No. 60/609,619, filed on Sep. 13, 2004.

(51) Int. Cl. G02B 6/26

(52) U.S. Cl. 385/5; 385/16

(57) ABSTRACT

A bistable photonic crystal configuration comprises a waveguide sided coupled to a single-mode cavity. This configuration can generate extremely high contrast between the bistable states in its transmission with low input power. All-optical switching action is also achieved in a nonlinear photonic crystal cross-waveguide geometry, in which the transmission of a signal can be reversibly switched on and off by a control input, or irreversibly switched, depending on the input power level.

### CROSS-REFERENCE TO RELATED APPLICATIONS

This application claims priority from Provisional Application No. 60/609,619 filed Sep. 13, 2004, which is incorporated herein by reference in its entirety. This application is a continuation-in-part of U.S. application Ser. No. 10/421,337, entitled “OPTIMAL BISTABLE SWITCHING IN NON-LINEAR PHOTONIC CRYSTALS,” filed Apr. 23, 2003 (referred to herein as “parent application”), which was published Feb. 19, 2004 as U.S. Publication No. 2004/0033009 A1, and which is incorporated herein by reference in its entirety.

### BACKGROUND OF THE INVENTION

The invention relates to the field of optical devices, and in particular to bistable optical devices in non-linear photonic crystals.

Optical bistable devices are of great importance for all-optical information processing applications. See, for example, H. M. Gibbs, Optical Bistability: Controlling Light with Light (Academic Press, Orlando, 1985). As disclosed in the parent application, optical bistability can be achieved in a nonlinear photonic crystal. This concept is also described in E. Centeno and D. Felbacq, Phys. Rev. B 62, R7683 (2000); S. F. Mingaleev and Y. S. Kivshar, J. Opt. Soc. Am. B 19, 2241 (2002); M. Soljacic, M. Ibanescu, S. G. Johnson, Y. Fink and J. D. Joannopoulos, Phys. Rev. E 66, 55601 (R) (2002); M. Soljacic, C. Luo, J. D. Joannopoulos and S. Fan, Opt. Lett. 28, 637 (2003).

The use of photonic crystal resonator results in greatly reduced power requirements. For practical applications of integrated two-port bistable devices, however, an important consideration is the contrast ratio in the transmission between the two bistable states. A high contrast ratio is beneficial for maximum immunity to noise and detection error, and for fan out considerations. The contrast ratio of prior devices may still be too low for a number of applications. Furthermore, the input power necessary for operation of prior devices may be too high to be practical for many applications. It is therefore desirable to provide bistable devices with improved characteristics.

### SUMMARY OF THE INVENTION

According to one aspect of the invention, an optical bistable switch comprises a photonic crystal cavity structure; and a waveguide structure coupled to the cavity structure so that the cavity structure exhibits a bistable dependence on power of an input signal to the waveguide. Thus, when an optical signal is applied to the waveguide structure, the switch is caused to be in a high transmission state. Then when a pulse optical signal is applied to the waveguide structure, the switch is caused to be in a low transmission state. In one embodiment, the photonic crystal cavity structure is side coupled to the waveguide; this embodiment has high contrast ratio and may be operated at lower input power.

According to another aspect of the invention, an optical bistable device comprises a photonic crystal cavity structure; and a plurality of waveguide structures coupled to the cavity structure so that the cavity structure exhibits a bistable dependence on power of signals supplied to it, at least a first one of said waveguide structures to receive an input signal to said device, at least a second one of said waveguide structures to provide an output signal and at least a third one of said waveguide structures to convey a control signal to said device. When an input signal supplied to the first one of said waveguide structures; and a control signal is supplied to the third one of said waveguide structures, the output signal is caused to be at a higher or lower level.

### BRIEF DESCRIPTION OF THE DRAWINGS

FIG. 1(a) is a schematic configuration for a waveguide directly coupled to a cavity.

FIG. 1(b) is a schematic configuration for a waveguide side-coupled to a cavity.

FIG. 2(a) is a schematic view of a photonic crystal with a line defect and a localized (e.g. point defect) to illustrate one embodiment of the configuration in FIG. 1 (b).

FIG. 2(b) is a graphical plot of input versus output power for the side-coupled photonic crystal cavity structure shown in FIG. 2(a). Open circles are results from FDTD simulations, and the solid line is calculated using Equation 1. The arrows show the hysteresis loop.

FIG. 3(a) is a graphical plot of electric field distributions in the photonic crystal structure for the high transmission state.

FIG. 3(b) is a graphical plot of electric field distributions in the photonic crystal structure for the low transmission state. The input power is 3.95P₀ for both high and low transmission states. Areas labeled +and − represent large positive or negative electric fields, respectively. The black circles indicate the positions of the dielectric rods in the photonic crystal.

FIG. 4 is a graphical plot of input and output powers as a function of time. The input power curve is in a dashed line; the output power levels calculated by FDTD simulations are shown in open circles, and the output power levels calculated by the coupled mode theory (Equation 2 below) is also labeled accordingly.

FIG. 5(a) is a schematic view of a photonic crystal cross-waveguide switch and the electric field distributions in it when control input is absent and signal output is low.

FIG. 5(b) is a schematic view of a photonic crystal cross-waveguide switch and the electric field distributions in it when control input is present and signal output is high. The control and input signal power are both about 200 mW/μm. Areas labeled +and − represent large positive or negative electric fields, respectively. The same color scale is used for both panels. The black circles indicate the positions of the dielectric rods in the photonic crystal.

FIG. 6 is a graphical plot of input versus output power for the signal in waveguide X, calculated using Equation 3 below, by keeping output power in waveguide Y (and hence the energy in cavity mode Y) at constant levels. Curves r, g and b correspond to control output powers of 0, 151 , and 75 respectively, which is appropriate for various times in the switching process as shown in FIG. 7.

FIG. 7 is a graphical plot of the input and output power level for the input signal and the control as a function of time. The lines are from coupled-mode theory calculations using equations 3 and 4, and the open circles and triangles are from FDTD simulations. The labels A, B, and B′ indicate the control output power levels that were used to calculate the bistability curves of FIG. 6.

For simplicity ion description, identical components are labeled by the same numerals in this application.

### DETAILED DESCRIPTION OF EXEMPLARY EMBODIMENTS

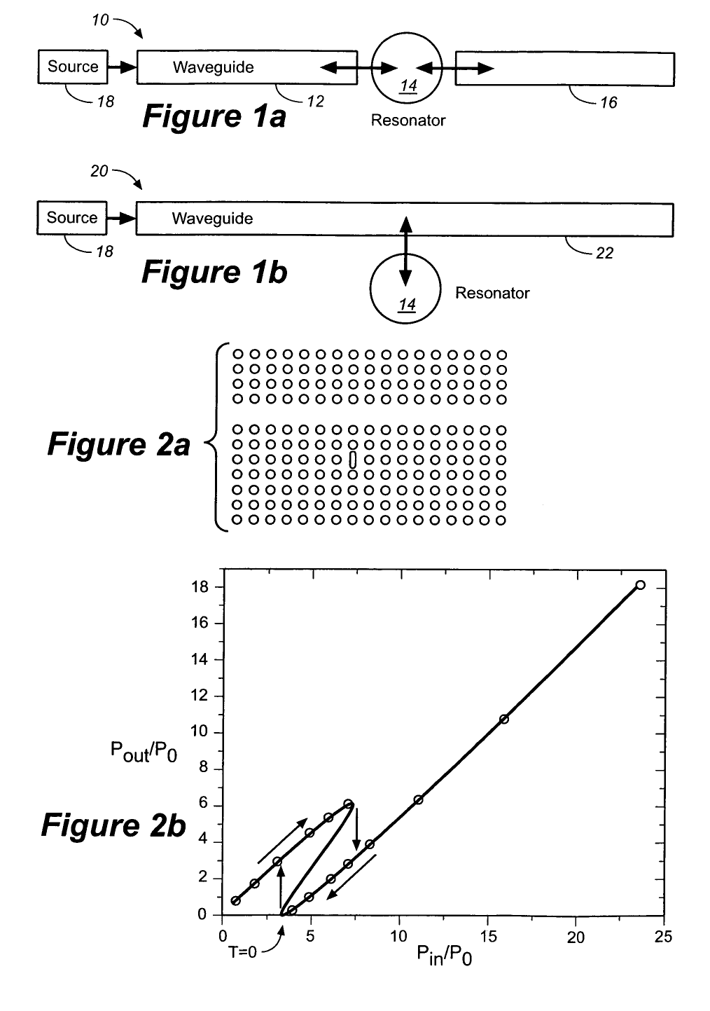

In this application, we introduce an alternative photonic crystal configuration with greatly improved contrast ratio in its transmission. We also provide an analytic theory that can account for the switching dynamics in nonlinear photonic crystal structures. Two-port photonic crystal devices based upon direct-coupled resonator geometry are illustrated in FIG. 1(a), where the cavity is situated between and coupled to two waveguides: an input and an output waveguide. See also E. Centeno and D. Felbacq, Phys. Rev. B 62, R7683 (2000); S. F. Mingaleev and Y. S. Kivshar, J. Opt. Soc. Am. B 19, 2241 (2002); M. Soljacic, M. Ibanescu, S. G. Johnson, Y. Fink and J. D. Joannopoulus, Phys. Rev. E 66, 55601 (R) (2002).

In contrast, our proposed configuration comprises a waveguide side-coupled to a single mode cavity with Kerr nonlinearity as illustrated in FIG. 1(b) which employs direct-coupled resonator geometry. The optical energy inside the cavity can exhibit bistable dependency on the incident power level, and can switch between two states with either low or high optical energy. In general, due to weakness of nonlinearity, it may be useful to choose the operating frequency to be in the vicinity of the resonant frequency in order to reduce the incident power requirement. Doing so, however, also decreases the ratio of the optical energy of the two states inside the resonator.

FIG. 1(a) is a schematic configuration for an input waveguide 12 and an output waveguide 16 directly coupled to a cavity 14. In the direct-coupled resonator geometry 10 as shown in FIG. 1(a), the transmitted power at the output of waveguide 16 originating from a radiation source 18 after propagating through the resonator or cavity 14 is proportional to the optical energy inside the cavity. Thus the contrast ratio in the transmitted power becomes limited. In comparison, for the side-coupled geometry 20 of FIG. 1(b), one could take advantage of the interference between the propagating wave inside the waveguide 22 and the decaying wave from the cavity 14, to greatly enhance achievable contrast ratio in the transmission between the two bistable states.

Using a similar procedure as outlined in the parent application and in M. Soljacic, M. Ibanescu, S. G. Johnson, Y. Fink and J. D. Joannopoulus, Phys. Rev. E 66, 55601 (R) (2002), the transmitted power ratio T for a nonlinear side-coupled resonator can be analytically written as:

$$T ≡ \frac{{P}_{trans}}{{P}_{in}} = \frac{{( {P}_{ref} \text{/} {P}_{0} - δ )}^{2}}{1 + {( {P}_{ref} \text{/} {P}_{0} - δ )}^{2}} \qquad ( 1 )$$

where Pᵢₙ, P_{ref} and Pₜᵣₐₙₛ are respectively the input, reflected, and transmitted powers such that Pᵢₙ=Pₜᵣₐₙₛ+P_{ref}·P₀=1/[κQ²ωᵣₑₛn₂(r)|ₘₐₓ/c] is the characteristic power of the cavity and κ is the dimensionless scale invariant nonlinear feedback parameter proportional to the overlap of the cavity mode with the nonlinear region. See M. Soljacic, M. Ibanescu, S. G. Johnson, Y. Fink and J. D. Joannopoulus, Phys. Rev. E 66, 55601 (R) (2002). The input power may be supplied by optical source 18 of FIG. 1(b).

FIG. 1(b) is a schematic configuration 20 for a waveguide 22 side-coupled to a cavity 14. FIG. 2(a) is a schematic view of a photonic crystal with a line defect and a localized (e.g. point defect) to illustrate one embodiment of the configuration in FIG. 1(b), where the optical source is omitted. In the embodiment of FIG. 2(a), δ=(ωᵣₑₛ−ω₀)/γ is the detuning of the incident excitation frequency ω₀ from the cavity resonance frequency ωᵣₑₛ, and the cavity decay rate γ is related to the cavity quality factor Q by γ=ωᵣₑₛ/(2·Q)·n₂(r) and c are respectively the spatially varying Kerr coefficient, and the speed of the light. For a particular set of parameters to be detailed below, the behavior of Pₜᵣₐₙₛ as a function of Pᵢₙ is shown as the solid line in FIG. 2(b). Although the material response is instantaneous, this device displays memory effects such that its current state depends not only on the current input but also on the past state of the system, yielding the hysteric trajectories shown in FIG. 2(b). We note that one of the bistable states can possess near-zero transmission coefficient, and thus the contrast ratio can be infinitely high. This occurs when there is sufficient energy inside the cavity such that the resonance frequency of the cavity coincides with that of the incident field. Thus, in one embodiment, the ratio of output power of the switch in the low transmission state to output power of the switch in the high transmission state is preferably less than about one to ten.

FIG. 2(a) is a physical implementation of the theoretical idea shown in FIG. 2(b) above using the side coupled geometry (but where source 18 is omitted for simplicity) of FIG. 1(b). The crystal comprises a square lattice of high dielectric rods (n=3.5) with a radius of 0.2a, (a is the lattice constant) embedded in air (n=1). We introduce the waveguide (line defect) into the crystal by removing a line of rods, and create a side-coupled cavity that supports a single resonant state by introducing a localized defect (e.g. point defect) with an elliptical dielectric rod, with the long and short axis lengths of a and 0.2a, respectively. The defect region possesses instantaneous nonlinear Kerr response with a Kerr coefficient of n₂=1.5×10⁻¹⁷ W/m², which is achievable using nearly instantaneous nonlinearity in many semiconductors. See M. Sheik-Bahae, D. C. Hutchings, D. J. Hagan and E. W. Van Stryland, IEEE J. Quantum Electron. 27, 1296 (1991). The use of the elliptical rod generates a single mode cavity and also enhances the field localization in the nonlinear region.

We perform nonlinear Finite Difference Time Domain (FDTD) simulations. See A. Taflove and S. C. Hagness, Computational Electrodynamics (Artech House, Norwood Mass., 2000) for the TM case with electric field parallel to the rod axis for this photonic crystal system. The simulations use 12×12 grid points per unit cell, and incorporate a Perfectly Matched Layer (PML) boundary condition specifically designed for photonic crystal waveguide simulations. See M. Koshiba and Y. Tsuji, IEEE Microwave and Wireless Comp. Lett. 11, 152 (2001).

At a low incident power level where the structure behaves linearly, we determine that the cavity has a resonant frequency of ωᵣₑₛ=0.371·(2πc/a), which falls within the band gap of the photonic crystal, a quality factor of Q=4494, and a nonlinear feedback parameter κ=0.185. Using these parameters, the theory predicts a characteristics power level of P₀=4.4 mW /μm for 1.55 μm wavelength used in our simulations. For a three-dimensional structure, with the optical mode confined in the third dimension to a width about half a wavelength, the characteristic input power is only on the order of a few mW, such as not more than about 10 mW when the switching between states occurs.

To study the nonlinear switching behavior, we excite an incident Continuous Wave (CW) in the waveguide detuned by δ=2°\sqrt{3} from the cavity resonance. (δ=\sqrt{3} is the minimum detuning requirement for the presence of bistability). While a continuous wave optical signal is used in this example, it will be understood that this is not required, and other types of optical or other electromagnetic signals may be used. We vary the input power and measure the output power at steady state, as shown by the open circles in FIG. 2(b). In particular, we observe a bistable region between 3.39 P₀ and 7.40 P₀. The FDTD results (shown as open circles in FIG. 2(b)) fit almost perfectly with the theoretical prediction, generated using Equation (1) and exhibited as a solid line in FIG. 2(b). Note that on the theory curve, the region where there are no FDTD data points is unstable. The contrast ratio between the upper and lower branch approaches infinity as transmission drops to zero in the lower branch in transmission. The ratio of output power of the switch in the low transmission state to output power of the switch in the high transmission state may be less than about one to ten.

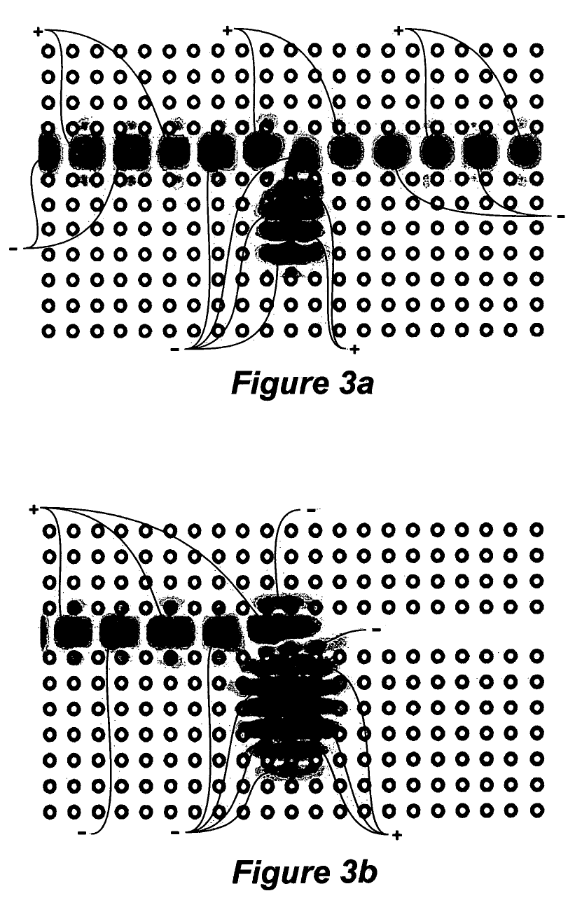

FIG. 3(a) is a graphical plot of electric field distributions in the photonic crystal structure for the high transmission state. FIG. 3(b) is a graphical plot of electric field distributions in the photonic crystal structure for the low transmission state. The input power is 3.95 P₀ for both high and low transmission states. Areas labeled + and − represent large positive or negative electric fields, respectively. The black circles indicate the positions of the dielectric rods in the photonic crystal.

FIGS. 3(a) and 3(b) show the field pattern for the two bistable states for the same input CW power level of 3.95 P₀. FIG. 3(a) corresponds to the high transmission state. In this state, the cavity is off resonance with the excitation. The field inside the cavity is low, and thus the decaying field amplitude from the cavity is negligible. FIG. 3(b) corresponds to the low transmission state. Here the field intensity inside the cavity is much higher, pulling the cavity resonance frequency down to the excitation frequency of the incident field. The decaying field amplitude from the cavity is significant, and it interferes destructively with the incoming field. Thus, it is indeed the interference between the wave propagating in the waveguide and the decaying amplitude from the cavity that result in the high contrast ratio in transmission.

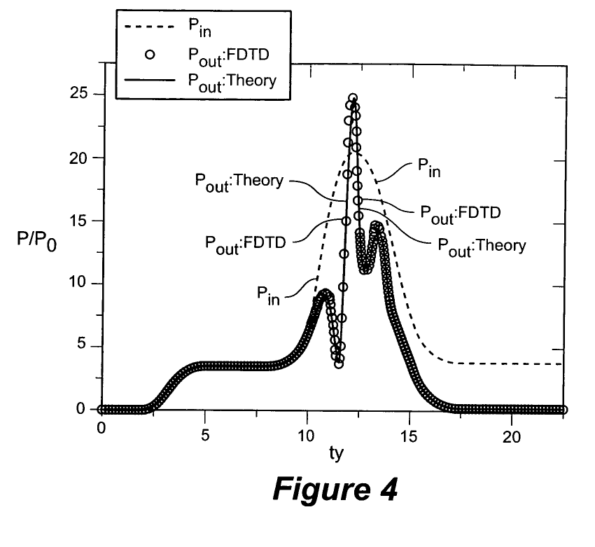

FIG. 4 is a graphical plot of input and output powers as a function of time. The input power curve is in a dashed line; the output power levels calculated by FDTD simulations are shown in open circles, and the output power levels calculated by the coupled mode theory (Equation 2 above) is also labeled accordingly.

The FDTD analysis also reveals that the transmission can be switched to the lower branch from the upper branch with a pulse. FIG. 4 shows the peak power in each optical period in the waveguide as a function of time, as we switch the system between the two bistable states shown in FIGS. 3(a) and 3(b). As the input is initially increased to the CW power level of 3.95 P₀, the system evolves into a high transmission state, with the transmitted power of 3.65 P₀. The switching then occurs after a pulse, which possesses a peak power 20.85 P₀, the same carrier frequency as that of CW, and a rise time and a width equal to the cavity lifetime, is superimposed upon the CW excitation. The pulse pushes the stored optical energy inside the cavity above the bistable threshold. After the pulse has passed through the cavity, the system switches to the bistable state with low transmission power of 0.25 P₀.

The switching dynamics, as revealed by the FDTD analysis, can in fact be completely accounted for with temporal coupled mode theory. The coupled mode equations (see H. A. Haus, Waves and Fields in Optoelectronics (Prentice-Hall, New Jersey, 1984)); relating the input, reflected, and transmitted power can be expressed in the following form for the side-coupled cavity structure

$$\frac{ⅆ {S}_{ref}}{ⅆ t} = {ⅈω}_{res} ( 1 - \frac{1}{2 Q} \frac{{\vert {S}_{ref} \vert}^{2}}{{P}_{0}} ) {S}_{ref} - γ {S}_{ref} - γ {S}_{in} \qquad ( 2 )$$

where Sᵢₙ, S_{ref} are proportional to the incident and reflected field amplitudes such that Pᵢₙ=|Sᵢₙ|², P_{ref}=|S_{ref}|², and Pₒᵤₜ=Pᵢₙ−P_{ref}. It is important to note that the FDTD analysis takes into account the full effects of the nonlinearity. The coupled mode theory, on the other hand, neglects higher harmonics of the carrier frequency generated by the nonlinearity. Nevertheless, since the switching and the cavity decay time scales are far larger than the optical period, the agreements between the coupled mode theory and FDTD simulations are excellent as shown in FIG. 4. Thus, for the first time, we show that the nonlinear dynamics in photonic crystal structures can be completely accounted for using coupled mode theory, which provides a rigorous and convenient framework for analyzing complex nonlinear processes and devices.

To cause the system to switch from the low transmission state back to the high transmission state, one would turn off the source 18 so that no input optical signal is supplied to waveguide 22 of FIG. 1(b). Then, the source is turned on again to supply input optical signal to waveguide 22 of FIG. 1(b). The system of FIG. 1(b) will then be in the high transmission state.

Another embodiment is based on the geometry in FIGS. 7A and 7B of the parent application. In the linear regime, this geometry enables intersection of two waveguides without any cross talk between them. The crystal consists of a square lattice of high dielectric rods (n=3.5) with a radius of 0.2a, (ais the lattice constant) embedded in air (n=1), and possesses a band gap for TM modes with electric field parallel to the rod axis. The waveguides are formed by removing a line of rods along either the x or y axis. The intersection consists of a cavity that supports two dipole modes. Each cavity mode is even with respect to one of the waveguide axis, and odd with respect to the other one. Since the waveguide modes are even with respect to the waveguide axis, each waveguide couples only to the cavity mode with the same symmetry, thus prohibiting any cross talk.

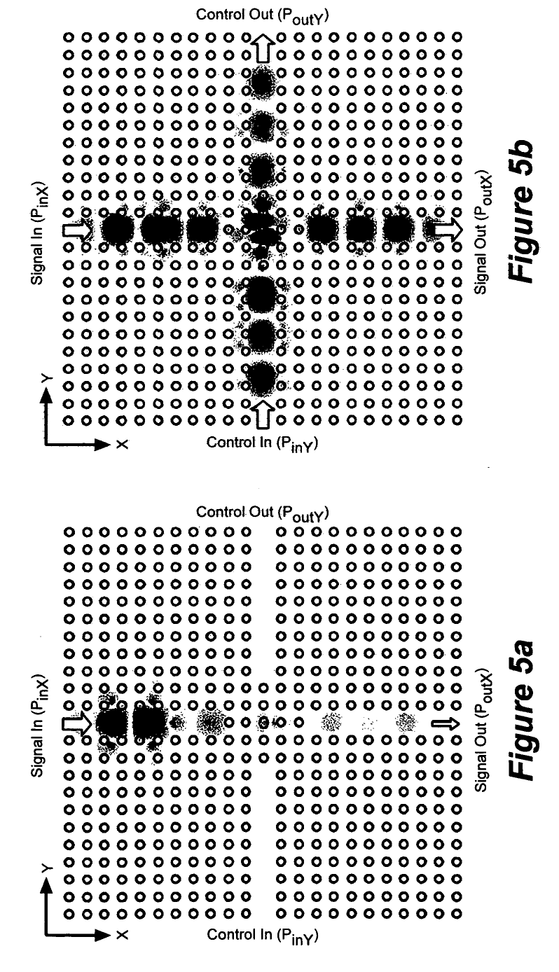

We create a nonlinear optical switch using this geometry by introducing Kerr nonlinearity to the rod at the center of the cavity. We show that this system allows a control in one waveguide to switch on or off the transmission of a signal in another waveguide as illustrated in FIGS. 5(a) and 5(b), and that there is no energy exchange between the signal (Pinx, Poutx) and control (Piny, Pouty) even in the nonlinear regime, which is essential for densely integrated optical circuits. In addition, this structure can be easily configured such that the signal and control operate at different frequencies, which is beneficial for wavelength division multiplexing. In the structure as shown in FIGS. 5(a) and 5(b), for example, we accomplish a spectral separation of the control and the signal by using a cavity with an elliptical dielectric rod, with the axis lengths of 0.54a and 0.64a, respectively along the x and y directions.

The dynamic behavior of the system can be described using the following coupled mode equations:

$$\frac{ⅆ {S}_{outX}}{ⅆ t} = {ⅈω}_{X} {S}_{outX} - i {γ}_{X} ( \frac{{\vert {S}_{outX} \vert}^{2}}{{P}_{XX}} + 2 \frac{{\vert {S}_{outY} \vert}^{2}}{{P}_{XY}} ) {S}_{outX} + {γ}_{X} \\ ( {S}_{inX} - {S}_{outX} ) - i {γ}_{X} \frac{{S}_{outY}^{2}}{{P}_{XY}} {S}_{outX}^{*} \\ \frac{ⅆ {S}_{outY}}{ⅆ t} = {ⅈω}_{Y} {S}_{outY} - i {γ}_{Y} ( \frac{{\vert {S}_{outY} \vert}^{2}}{{P}_{YY}} + 2 \frac{{\vert {S}_{outX} \vert}^{2}}{{P}_{YX}} ) {S}_{outY} + {γ}_{Y} \\ ( {S}_{inY} - {S}_{outY} ) - i {γ}_{Y} \frac{{S}_{outX}^{2}}{{P}_{YX}} {S}_{outY}^{*} \qquad ( 4 )$$

Sᵢₙ₍ₒᵤₜ₎′ⱼ is proportional to the field amplitude such that Pᵢₙ₍ₒᵤₜ₎ⱼ=|Sᵢₙ₍ₒᵤₜ₎ⱼ|² is the input(output) power in waveguide j. The subscripts X and Y label either the waveguide that is parallel to either the x or the y axis respectively, or the cavity mode that couples to the waveguide. γⱼ=ωⱼ/2Qⱼ is the decay rate for cavity mode j. Pᵢⱼ=1/[2αᵢⱼ(ωᵢ/c)^{d-1}n₂QᵢQⱼ] are the characteristic powers of the system with

$${α}_{ij} = {( \frac{c}{{ω}_{i}} )}^{d} \frac{{\int }_{vol} {ⅆ}^{d} r [ {\vert {E}_{i} ( r ) \cdot {E}_{j} ( r ) \vert}^{2} + 2 {\vert {E}_{i} ( r ) \cdot {E}_{j}^{*} ( r ) \vert}^{2} ] {n}^{2} ( r ) {n}_{2} ( r )}{[ {\int }_{vol} {ⅆ}^{d} r {\vert {E}_{i} ( r ) \vert}^{2} {n}^{2} ( r ) ] [ {\int }_{vol} {ⅆ}^{d} r {\vert {E}_{j} ( r ) \vert}^{2} {n}^{2} ( r ) ] {{n}_{2} ( r )}_{max}} , \qquad ( 5 )$$

where the α's are the generalization of the dimensionless scale-invariant nonlinear feedback parameter defined in M. Soljacic, M. Ibanescu, S. G. Johnson, Y. Fink and J. D. Joannopoulos, Phys. Rev. E 66, 55601 (R) (2002); here αᵢᵢ and αᵢᵢ are the self and cross modal overlap factors for the two cavity modes i and j, and are obtained from the first order perturbation theory in terms of the electric fields in the cavity modes Eᵢ₍ⱼ₎(r)=[Eᵢ₍ⱼ₎(r)exp(iωt)+Eᵢ₍ⱼ₎*(r)exp(−iωt)]/2. n₂, ωⱼ, a and c are respectively the instantaneous Kerr non-linearity coefficient, the angular frequency of the cavity mode j, the lattice constant of the photonic crystal, and the speed of the light. The last terms on the right side of Equations (3) and (4) describe a nonlinear energy exchange process between the control and the signal, which become negligible when the frequencies of the signal and control inputs, and the corresponding resonances of the cavity modes are separated by more than the width of the resonances, as is done in our simulations.

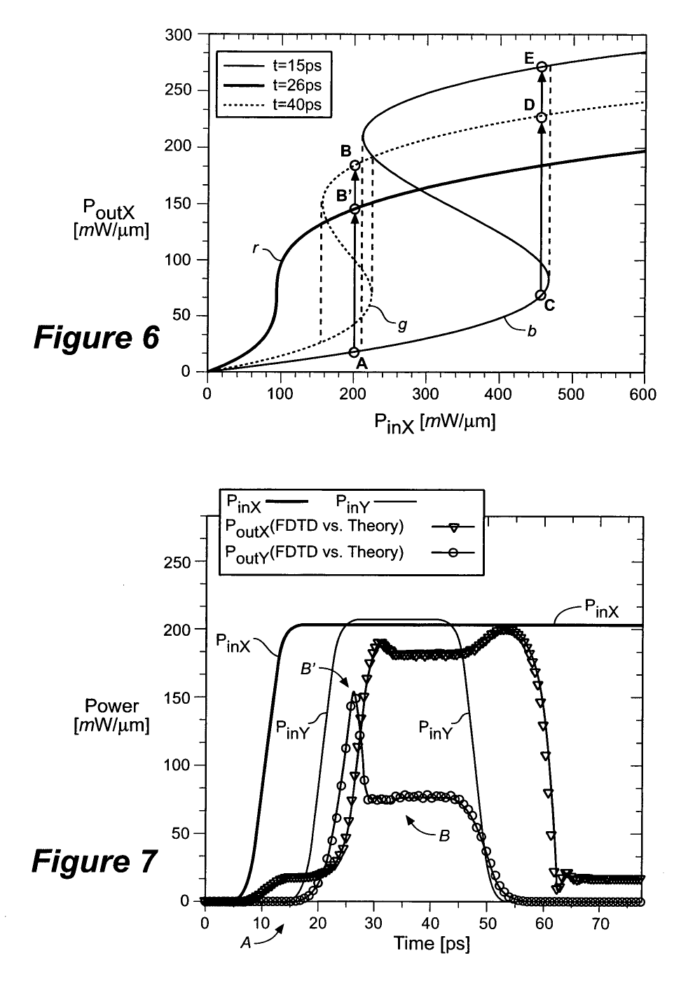

Using Equations (3)-(4), the general switching behavior of the system can be understood qualitatively as follows: In the absence of the control beam (i.e. S_{inY}=0), the signal output versus signal input exhibits the typical bistable shape in a transmission resonator configuration, (see H. A. Haus, Waves and Fields in Optoelectronics (Prentice-Hall, New Jersey, 1984)) as shown with the solid line b in FIG. 6. Suppose the signal output level is originally at point A in FIG. 6. Applying a control beam, (i.e. non-zero S_{inY} and S_{outY}) shifts the frequency of the mode X by an amount that is proportional to |S_{outY}|². The bistable transition threshold of the signal is thus decreased (e.g. the r curve, FIG. 6, where the output power is at point B′), resulting in an abrupt transition in the signal output power from that at point A to that at point B′. Therefore, at a given signal input power, the control can stimulate transitions between the bistable states, and generate high contrast logic levels. When the control is turned off, the bistability curve for the signal output moves back to the b curve, and the signal output drops to the original level at point A if the input power level remains unchanged. We note that the criterion for such reversible switching is that the signal input power level lies below the bistable threshold in the absence of the control. For a higher signal input power, (for example, point C in FIG. 6), the signal output stays at a higher power level (point E) after the control is turned off.

Hence, by controlling the signal input power level relative to the bistable threshold in the absence of the control, it is possible to determine whether transitions between the bistable states are reversible. When the signal input power level is below the bistable threshold in the absence of the control (e.g. point A), transitions between the bistable states are reversible. This is particularly useful for switches and switching functions, and the geometry of FIGS. 5(a) and 5(b) can function as transistors. When the signal input power level is above the bistable threshold in the absence of the control (e.g. point C), transitions between the bistable states are not reversible. This is particularly useful for memory functions, and the geometry of FIGS. 5(a) and 5(b) can function as memories. The signal and control may be carried by input and output channels such as optical fibers (not shown), where the input signals (Pinx, Piny) may originate from radiation sources (not shown).

Since the transmission of the control is also being modulated by the signal, detailed switching dynamics is more complicated than the qualitative discussions presented above. Below, we present a rigorous analysis by combining FDTD simulations with coupled mode theory. We show that the mutual coupling between the signal and control can lead to significant improvements in the switching contrast.

We employ the same nonlinear Finite Difference Time Domain (FDTD) simulations. See A. Taflove and S. C. Hagness, Computational Electrodynamics (Artech House, Norwood Mass., 2000), as in M. F. Yanik, S. Fan and M. Soljacic, Appl. Phys. Lett. (To be published). We choose a Kerr coefficient of n₂=1.5×10 ⁻¹⁷ W/m², achievable using nearly instantaneous non-linearity in AlGaAs below half the electronic band-gap at 1.55 μm. See M. N. Islam, C. E. Soccolich, R. E. Slusher, A. F. J. Levi, W. S. Hobson and M. G. Young, J. Appl. Phys. 71, 1927 (1992) and A. Villeneuve, C. C. Yang, G. I. Stegeman, C. Lin and H. Lin, J. Appl. Phys. 62, 2465 (1993).

At a low incident power where the structure behaves linearly, we determine that the cavity modes have resonance frequencies of ω_{X}=0.373·(2πc/a) and ω_{Y}=0.355·(2πc/a), which fall within the band gap of the photonic crystal, quality factors of Q_{X}=920 and Q_{Y}=1005, and non-linear modal overlap factors of α_{XX}=0.154, α_{YY}=0.172, α_{XY}=0.051 and α_{YX}=0.056. Using these parameters and a lattice constant of a=575 nm, the theory predicts characteristic powers of P_{XX}=62.75 mW/μm, P_{YY}=49.26 mW/μm, P_{XY}=172.55 mW/μm, and P_{YX}=164.32 mW/μm.

To demonstrate the transistor action, we launch a signal in waveguide X with carrier frequency ω_{inX} detuned by δ_{X}≡(ω_{X}−ω_{inX})/γ_{X}=2\sqrt{3} from the resonance of the cavity mode X as shown with the solid blue line in FIG. 3. (δ=°\sqrt{3} is the minimum detuning threshold for the presence of bistability in the absence of control input). The power of the input P_{inX}=200 m W/μm is selected to be below the bistable region in the absence of the control input (point A on the blue curve in FIG. 2). The field pattern of the steady state at t=15 ps is shown in FIG. 1a. After the steady state has been reached, we launch a control pulse with detuning δ_{Y}≡(ω_{Y}−ω_{inY})/γ_{Y}=1.4\sqrt{3} and power of P_{inY}=205 mW/μm in waveguide Y as shown with the solid line Piny in FIG. 7. The control switches the signal output to a higher level in approximately 10 ps (point B on the bistability curve g in FIG. 6). The field pattern of the steady state in the presence of the control is shown in FIG. 5(b). And finally, we turn off the control at t=45 ps, and the signal output returns back to low transmission state, completing a reversible switching cycle. There is excellent agreement between our FDTD results and coupled mode theory using equations (3) & (4). See M. F. Yanik, S. Fan and M. Soljacic, “High Contrast Bistable Switching in Photonic Crystal Microcavities”, Applied Physics Letters, 83, 2739 (2003).

An interesting feature in FIG. 7 is the presence of a peak in the control output during the initial transient period (labeled as B′ in FIG. 7). As the control input is switched on, the power in the mode Y initially increases, which induces the transition in signal output from point A to point B′ by moving the bistability curve for the signal from the curve b to the curve r in FIG. 6. In the mean time, however, as the energy increases in the cavity modes, the frequency of mode Y also starts to shift downward, detuning the frequency of mode Y from the control input, and eventually reduces the energy in mode Y from its peak value and moves the bistability curve for the signal from the curve r to the curve g in FIG. 6. Such a collective dynamics can thus be used to generate high contrast in signal output (point B in FIG. 7) with low power threshold. To exploit this effect, we have chosen a finite detuning δ_{Y}=1.4\sqrt{3} of the control input from the cavity resonance Y.

We note from equations (3) and (4) that the nonlinearity does not mix the signal and control outputs when their frequencies are separated by more than the cavity resonance widths. This is confirmed also in the FDTD simulations by analyzing the spectra at the two output ports during the entire switching process.

The structure has a footprint of a few μm². For 10 Gbit/s applications, one could use cavities with in-plane quality factors of approximately Q_{X(Y)}≈5000, achievable in photonic crystal slabs. See K. Srinivasan and O. Painter, Opt. Express 10, 670 (2002).

Since the bistability power threshold scales as 1/Q², for a three-dimensional structure operating at 1.55 μm, with the optical mode confined in the third dimension to a width about half a wavelength, the power requirement is only a few mW's while relative index shift δn/n is less than 10⁻³, achievable in materials with instantaneous Kerr nonlinearity. The contrast ratio between the on and off states is about 10, and further reduction by orders of magnitude in power requirement and index shift is achievable by using smaller detunings δ_{X(Y)}. Finally, the switching is robust against fluctuations in the system parameters and power levels.

While the invention has been described above by reference to various embodiments, it will be understood that changes and modifications may be made without departing from the scope of the invention, which is to be defined only by the appended claims and their equivalent. For example, while the invention is illustrated by rods in air, the invention can also be implemented by means of a periodic arrangement of holes in a photonic crystal such as a dielectric material where defects for forming the cavities as well as waveguide comprise holes in the material of sizes different from those in the arrangement, and may contain a material different from that in the holes in the arrangement. Incident Continuous Wave (CW) in the waveguide have been used to illustrate some aspects of the invention (e.g. with respect to the embodiment of FIGS. 2(a) and 2(b)). It will be understood that this is not required, and other types of optical or other electromagnetic signals may be used as well and are within the scope of the invention. All references referred to herein are incorporated by reference in their entireties.

What is claimed is:

1. An optical bistable switch comprising:
a photonic crystal cavity structure; and
a waveguide structure coupled to the cavity structure so that the cavity structure exhibits a bistable dependence on power of an input signal to the waveguide.

2. The switch of claim 1, wherein said cavity structure is side coupled to the waveguide structure.

3. The switch of claim 1, wherein said waveguide structure comprises a line defect in a photonic crystal, and the cavity structure comprises a localized defect at a distance from the line defect.

4. The switch of claim 1, further comprising a source supplying electromagnetic signals to the waveguide structure.

5. The switch of claim 4, wherein said source supplies an optical signal to the waveguide structure, causing the switch to be in a high transmission state.

6. The switch of claim 5, wherein said source supplies a continuous wave optical signal to the waveguide structure.

7. The switch of claim 5, wherein said source also supplies a pulse optical signal to the waveguide structure, causing the switch to be in a low transmission state.

8. The switch of claim 5, wherein said source stops supplying optical signals to the waveguide structure, and subsequently resumes supplying an optical signal to the waveguide structure, causing the switch to be in a high transmission state.

9. The switch of claim 5, wherein ratio of output power of the switch in the low transmission state to output power of the switch in the high transmission state is less than about one to ten.

10. The switch of claim 4, said source supplying powers equal to or less than about 10 milliwatts when the switch switches between two different states.

11. The switch of claim 1, said photonic crystal cavity structure comprising a plurality of rods or holes in a material.

12. An optical bistable switching method employing:
a photonic crystal cavity structure; and
a waveguide structure coupled to the cavity structure so that the cavity structure exhibits a bistable dependence on power of an input signal to the waveguide, said method comprising:
applying an optical signal to the waveguide structure, causing the switch to be in a high transmission state; and
applying a pulse optical signal to the waveguide structure, causing the switch to be in a low transmission state.

13. The method of claim 12, wherein said applying of an optical signal applies a continuous wave optical signal to the waveguide structure.

14. The method of claim 12, further comprising:
stopping the application of optical signals to the waveguide structure; and
subsequently resuming the application of an optical signal to the waveguide structure, causing the switch to be in a high transmission state.

15. An optical bistable device comprising:
a photonic crystal cavity structure; and
a plurality of waveguide structures coupled to the cavity structure so that the cavity structure exhibits a bistable dependence on power of signals supplied to it, at least a first one of said waveguide structures receiving an input signal applied to said device, at least a second one of said waveguide structures providing an output signal and at least a third one of said waveguide structures providing a control signal to said device.

16. The device of claim 15, said control signal causing the output signal to be at a higher or lower level.

17. The device of claim 16, said first one of said waveguide structures receiving an input signal applied to said device, wherein when the third one of said waveguide structures providing a control pulse to said device, the output signal switches from the lower level to the higher level.

18. The device of claim 17, said first one of said waveguide structures receiving an input signal to said device, wherein when the third one of said waveguide structures stops providing a control pulse to said device, the output signal switches back from the higher level to the lower level.

19. The device of claim 17, said first one of said waveguide structures receiving an input signal to said device, wherein when the third one of said waveguide structures stops providing a control pulse to said device, the output signal remains at the higher level.

20. The device of claim 15, wherein said photonic crystal cavity structure comprises a plurality of rods or holes in a material.

21. The device of claim 15, wherein said cavity structure is located between the first and second ones of said waveguide structures, said device comprising a fourth waveguide structure, said cavity structure located between the third and fourth waveguide structures.

22. The device of claim 21, wherein said the third and fourth waveguide structures are substantially orthogonal to said first and second waveguide structures.

23. An optical bistable switching method employing a device which comprises:
a photonic crystal cavity structure; and
a plurality of waveguide structures coupled to the cavity structure so that the cavity structure exhibits a bistable dependence on power of signals supplied to it, at least a first one of said waveguide structures to receive an input signal to said device, at least a second one of said waveguide structures to provide an output signal and at least a third one of said waveguide structures to convey a control signal to said device, said method comprising:
supplying an input signal to the first one of said waveguide structures; and
supplying a control signal to the third one of said waveguide structures causing the output signal to be at a higher or lower level.

24. The method of claim 23, wherein when the control pulse is supplied to the third one of said waveguide structures, the output signal switches from the lower level to the higher level.

25. The method of claim 24, wherein power of said input signal supplied to the first one of said waveguide structures is such that, when no control pulse is supplied to the third one of said waveguide structures, the output signal switches from the higher level to the lower level.

26. The method of claim 24, wherein power of said input signal supplied to the first one of said waveguide structures is such that, when no control pulse is supplied to the third one of said waveguide structures, the output signal remains at the higher level.
